(19) United States
(12) Patent Application Publication
(10) Pub. No.: US 2013/0304743 A1
(43) Pub. Date: Nov. 14, 2013

(54) KEYWORD ASSIGNMENT DEVICE, INFORMATION STORAGE DEVICE, AND KEYWORD ASSIGNMENT METHOD

(71) Applicant: OLYMPUS CORPORATION, Tokyo (JP)

(72) Inventor: Emi KUROKAWA, Tokyo (JP)

(21) Appl. No.: 13/943,532

(22) Filed: Jul. 16, 2013

Related U.S. Application Data
(63) Continuation of application No. PCT/JP2012/051310, filed on Jan. 23, 2012.

(30) Foreign Application Priority Data
Jan. 26, 2011 (JP) 2011-013967

(51) Int. Cl. G06F 17/30

(52) U.S. Cl. CPC G06F 17/30598
USPC 707/740

(57) ABSTRACT

A keyword assignment device includes a class determination section that determines a corresponding class when a plurality of keywords are classified into a plurality of classes that are distributed in first to Nth hierarchies, a classification frequency calculation section that calculates a classification frequency of each class, a reference target hierarchy determination section that determines a reference target hierarchy, and a keyword determination section that determines the keyword of the corresponding class in the final reference target hierarchy to be a display keyword. The reference target hierarchy determination section determines a kth hierarchy to be the next reference target hierarchy when it has been determined that it is necessary to refer to the kth hierarchy that is higher than a jth hierarchy based on the classification frequency of the corresponding class in the jth hierarchy.

### CROSS REFERENCE TO RELATED APPLICATION

This application is a continuation of International Patent Application No. PCT/JP2012/051310, having an international filing date of Jan. 23, 2012 which designated the United States, the entirety of which is incorporated herein by reference. Japanese Patent Application No. 2011-013967 filed on Jan. 26, 2011 is also incorporated herein by reference in its entirety.

### BACKGROUND

The present invention relates to a keyword assignment device, an information storage device, a keyword assignment method, and the like.

A large number of images captured using a digital camera can be stored in the digital camera along with an increase in capacity of a memory or the like. The captured images may be transferred to an external instrument (e.g., personal computer (PC)), and stored together with images collected via the Internet and the like.

A technique has been proposed that allows the user to assign a keyword to each image, and easily find (search) the desired image from a large number of stored images via a keyword search process.

However, it takes time for the user to manually assign a keyword to each captured or collected image. This imposes a burden on the user.

In JP-A-2002-063172, a similar image that is similar to the keyword assignment target image is searched and extracted, and the keyword assigned to the extracted similar image is assigned to the keyword assignment target image.

### SUMMARY

According to one aspect of the invention, there is provided a keyword assignment device comprising:

a class determination section that determines a corresponding class based on a feature quantity extracted from an input image when a plurality of keywords are classified into a plurality of classes that are distributed in first to Nth (N is an integer equal to or larger than 2) hierarchies, the corresponding class being a class that corresponds to the input image;

a classification frequency calculation section that calculates a classification frequency of each class among the plurality of classes;

a reference target hierarchy determination section that determines a reference target hierarchy, the reference target hierarchy being a hierarchy that is referred to for the classification frequency; and

a keyword determination section that determines the keyword of the corresponding class in a final reference target hierarchy determined by the reference target hierarchy determination section to be a display keyword assigned to the input image,

the reference target hierarchy determination section determining whether or not it is necessary to refer to a kth (k is an integer that satisfies 1≦k<j) hierarchy that is higher than a jth (j is an integer that satisfies 1≦j≦N) hierarchy based on the classification frequency of the corresponding class in the jth hierarchy when the jth hierarchy is a current reference target hierarchy, and determining the kth hierarchy to be a next reference target hierarchy when the reference target hierarchy determination section has determined that it is necessary to refer to the kth hierarchy.

According to another aspect of the invention, there is provided a computer-readable storage device with an executable program stored thereon, the program instructs a computer to perform:

a class determination step that determines a corresponding class based on a feature quantity extracted from an input image when a plurality of keywords are classified into a plurality of classes that are distributed in first to Nth (N is an integer equal to or larger than 2) hierarchies, the corresponding class being a class that corresponds to the input image;

a classification frequency calculation step that calculates a classification frequency of each class among the plurality of classes;

a reference target hierarchy determination step that determines a reference target hierarchy, the reference target hierarchy being a hierarchy that is referred to for the classification frequency; and

a keyword determination step that determines the keyword of the corresponding class in a final reference target hierarchy determined by the reference target hierarchy determination step to be a display keyword assigned to the input image,

the reference target hierarchy determination step determining a kth (k is an integer that satisfies 1≦k<j) hierarchy to be a next reference target hierarchy when it has been determined that it is necessary to refer to the kth hierarchy that is higher than a jth (j is an integer that satisfies 1≦j≦N) hierarchy based on the classification frequency of the corresponding class in the jth hierarchy.

According to another aspect of the invention, there is provided a keyword assignment method comprising:

determining a corresponding class based on a feature quantity extracted from an input image when a plurality of keywords are classified into a plurality of classes that are distributed in first to Nth (N is an integer equal to or larger than 2) hierarchies, the corresponding class being a class that corresponds to the input image;

calculating a classification frequency of each class among the plurality of classes;

performing a reference target hierarchy determination process that determines whether or not it is necessary to refer to a kth (k is an integer that satisfies 1≦k<j) hierarchy that is higher than a jth (j is an integer that satisfies 1≦j≦N) hierarchy based on the classification frequency of the corresponding class in the jth hierarchy when the jth hierarchy has been determined to be a reference target hierarchy that is referred to for the classification frequency, and determines the kth hierarchy to be a next reference target hierarchy when it has been determined that it is necessary to refer to the kth hierarchy; and

determining the keyword of the corresponding class in a final reference target hierarchy determined by the reference target hierarchy determination process to be a display keyword assigned to the input image.

### BRIEF DESCRIPTION OF THE DRAWINGS

FIG. 1 illustrates a system configuration example according to one embodiment of the invention.

FIG. 2 is a flowchart illustrating a keyword assignment process according to one embodiment of the invention.

FIG. 3 is a flowchart illustrating a higher hierarchy reference process.

FIG. 4 illustrates an example of a feature space and classification.

FIG. 5 illustrates an example of classification using a classification tree.

FIG. 6 illustrates an example of an input image.

FIG. 7 is a view illustrating classification results using a feature space.

FIG. 8 illustrates an example of a classification frequency and a threshold value in a third hierarchy.

FIG. 9 illustrates an example of a classification frequency and a threshold value in a second hierarchy.

FIG. 10 is a view illustrating the correspondence between a corresponding class in a third hierarchy and a keyword to be assigned.

FIG. 11 is a view illustrating a method that determines a display keyword from a corresponding class.

FIG. 12 is a flowchart illustrating a process that determines a keyword that is displayed during a search process.

FIG. 13 illustrates an example in which a plurality of higher hierarchies correspond to one lower hierarchy.

### DESCRIPTION OF EXEMPLARY EMBODIMENTS

Several aspects of the invention may provide a keyword assignment device, an information storage device, a keyword assignment method, and the like that assigns a keyword while reflecting the preference of the user and the like by changing the hierarchy of the keyword assigned to the input image corresponding to the classification frequency of the keyword.

Several aspects of the invention may provide a keyword assignment device, an information storage device, a keyword assignment method, and the like that can assign a keyword corresponding to the preference (e.g., captured object) of the user by assigning a detailed keyword to a category that is considered to be of interest for the user, and assigning a broad keyword to a category that is not considered to be of interest for the user.

According to one embodiment of the invention, there is provided a keyword assignment device comprising:

a class determination section that determines a corresponding class based on a feature quantity extracted from an input image when a plurality of keywords are classified into a plurality of classes that are distributed in first to Nth (N is an integer equal to or larger than 2) hierarchies, the corresponding class being a class that corresponds to the input image;
a classification frequency calculation section that calculates a classification frequency of each class among the plurality of classes;

a reference target hierarchy determination section that determines a reference target hierarchy, the reference target hierarchy being a hierarchy that is referred to for the classification frequency; and
a keyword determination section that determines the keyword of the corresponding class in a final reference target hierarchy determined by the reference target hierarchy determination section to be a display keyword assigned to the input image,

the reference target hierarchy determination section determining whether or not it is necessary to refer to a kth (k is an integer that satisfies 1≦k<j) hierarchy that is higher than a jth (j is an integer that satisfies 1≦j≦N) hierarchy based on the classification frequency of the corresponding class in the jth hierarchy when the jth hierarchy is a current reference target hierarchy, and determining the kth hierarchy to be a next reference target hierarchy when the reference target hierarchy determination section has determined that it is necessary to refer to the kth hierarchy.

According to one embodiment of the invention, the reference target hierarchy can be determined when hierarchical classification is implemented, and whether or not it is necessary to refer to the higher hierarchy can be determined based on the classification frequency in the reference target hierarchy. This makes it possible to sequentially refer to the higher hierarchy from the first reference target hierarchy.

In the keyword assignment device,

the reference target hierarchy determination section may determine the jth hierarchy to be the final reference target hierarchy when the reference target hierarchy determination section has determined that it is unnecessary to refer to a hierarchy higher than the jth hierarchy based on the classification frequency of the corresponding class in the jth hierarchy, and

the keyword determination section may determine the keyword of the corresponding class in the jth hierarchy to be the display keyword assigned to the input image.

This makes it possible to stop referring to the higher hierarchy halfway, for example.

In the keyword assignment device,

the reference target hierarchy determination section may determine an Nth hierarchy that is a lowest hierarchy to be a first reference target hierarchy, and may determine whether or not it is necessary to refer to a hierarchy higher than the Nth hierarchy based on the classification frequency of the corresponding class in the Nth hierarchy,

the reference target hierarchy determination section may determine the hierarchy higher than the Nth hierarchy to be the next reference target hierarchy when the reference target hierarchy determination section has determined that it is necessary to refer to the hierarchy higher than the Nth hierarchy,

the reference target hierarchy determination section may determine the Nth hierarchy to be the final reference target hierarchy when the reference target hierarchy determination section has determined that it is unnecessary to refer to the hierarchy higher than the Nth hierarchy, and

the keyword determination section may determine the keyword of the corresponding class in the Nth hierarchy to be the display keyword assigned to the input image when the reference target hierarchy determination section has determined that it is unnecessary to refer to the hierarchy higher than the Nth hierarchy.

According to the above configuration, since the reference process can be started from the lowest hierarchy, the keyword of the corresponding class that belongs to an arbitrary hierarchy can be assigned to the input image as the display keyword, for example.

In the keyword assignment device,

the reference target hierarchy determination section may determine the kth hierarchy that is higher than the jth hierarchy to be the next reference target hierarchy when the classification frequency of the corresponding class in the jth hierarchy is smaller than a given threshold value, and

the reference target hierarchy determination section may no longer refer to a higher hierarchy when the classification frequency of the corresponding class in the jth hierarchy is larger than the given threshold value, and may determine the jth hierarchy to be the final reference target hierarchy.

This makes it possible to determine whether or not it is necessary to refer to the higher hierarchy by comparing the classification frequency with the threshold value, for example.

In the keyword assignment device,

the classification frequency calculation section may calculate the classification frequency based on n/m when the class determination section has determined one corresponding class or a plurality of corresponding classes for each input image among a plurality of input images, m being a total class determination count of a plurality of classes that belong to the reference target hierarchy, and n being a class determination count of a classification frequency reference target class.

This makes it possible to calculate the classification frequency by a simple process.

The keyword assignment device may further comprise:

a keyword display section that displays the keyword determined by the keyword determination section.

This makes it possible to display the keyword assigned to the input image, for example.

In the keyword assignment device,

the keyword display section may also present the keyword of the corresponding class in a hierarchy other than the reference target hierarchy determined by the reference target hierarchy determination section as a candidate.

According to the above configuration, since the keyword in the hierarchy other than the reference target hierarchy can be displayed, the keyword can be displayed in a flexible way, for example.

In the keyword assignment device,

the keyword of each class that belongs to the jth hierarchy may be a detailed keyword as compared with the keyword of each class that belongs to the kth hierarchy that is higher than the jth hierarchy.

This makes it possible to refer to a broad keyword from a detailed keyword, for example.

According to another embodiment of the invention, there is provided a computer-readable storage device with an executable program stored thereon, the program instructs a computer to perform:

a class determination step that determines a corresponding class based on a feature quantity extracted from an input image when a plurality of keywords are classified into a plurality of classes that are distributed in first to Nth (N is an integer equal to or larger than 2) hierarchies, the corresponding class being a class that corresponds to the input image;

a classification frequency calculation step that calculates a classification frequency of each class among the plurality of classes;

a reference target hierarchy determination step that determines a reference target hierarchy, the reference target hierarchy being a hierarchy that is referred to for the classification frequency; and

a keyword determination step that determines the keyword of the corresponding class in a final reference target hierarchy determined by the reference target hierarchy determination step to be a display keyword assigned to the input image,

the reference target hierarchy determination step determining a kth (k is an integer that satisfies 1≦k<j) hierarchy to be a next reference target hierarchy when it has been determined that it is necessary to refer to the kth hierarchy that is higher than a jth (j is an integer that satisfies 1≦j≦N) hierarchy based on the classification frequency of the corresponding class in the jth hierarchy.

According to another embodiment of the invention, there is provided a keyword assignment method comprising:

determining a corresponding class based on a feature quantity extracted from an input image when a plurality of keywords are classified into a plurality of classes that are distributed in first to Nth (N is an integer equal to or larger than 2) hierarchies, the corresponding class being a class that corresponds to the input image;

calculating a classification frequency of each class among the plurality of classes;

performing a reference target hierarchy determination process that determines whether or not it is necessary to refer to a kth (k is an integer that satisfies 1≦k<j) hierarchy that is higher than a jth (j is an integer that satisfies 1≦j≦N) hierarchy based on the classification frequency of the corresponding class in the jth hierarchy when the jth hierarchy has been determined to be a reference target hierarchy that is referred to for the classification frequency, and determines the kth hierarchy to be a next reference target hierarchy when it has been determined that it is necessary to refer to the kth hierarchy; and

determining the keyword of the corresponding class in a final reference target hierarchy determined by the reference target hierarchy determination process to be a display keyword assigned to the input image.

### 1. Method

A method employed in connection with several embodiments of the invention is described below. In recent years, it has become possible to acquire and store a large amount of image (photograph) data using an imaging device (e.g., digital camera) along with an increase in capacity and a reduction in price of a memory. Therefore, it is difficult to find the desired image data stored in the imaging device. It is more difficult to find the desired image data when the image data is transferred to a PC or the like in which image data downloaded from the Internet and the like are stored.

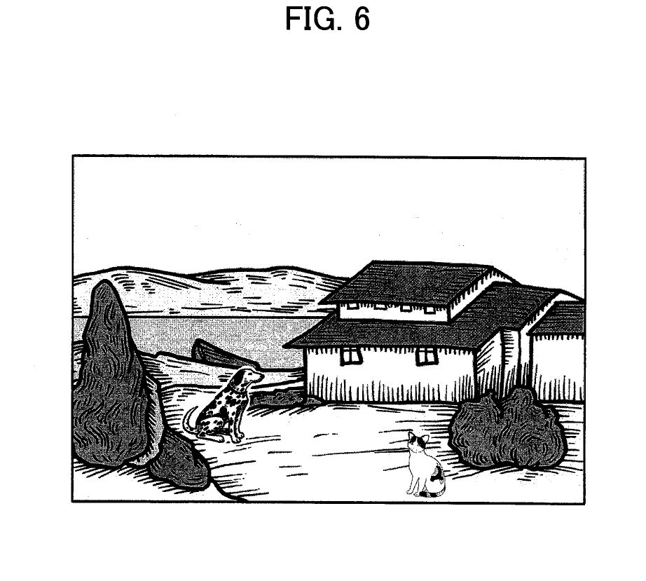

The above problem may be solved by assigning a keyword to the image data as metadata. For example, keywords “dog”, “cat”, “landscape”, and the like are assigned to the image data (image) illustrated in FIG. 6. In this case, the desired image data can be easily found (searched) by performing a classification process, a filtering process, or the like using the keyword.

However, a simple keyword assignment process has a problem in that the keyword assignment process does not reflect the preference of the user. Specifically, it is considered that most of the image data possessed by the user who likes to photograph a cat is cat image data. In this case, a keyword “cat” is not much useful for the search process. Specifically, when cat image data accounts for 80% of the image data, unnecessary data can be removed by only 20% even when the filtering process is performed using the keyword “cat”. Therefore, it is necessary to find the desired image data from a large amount of image data even when such a keyword is used.

In order to deal with the above problem, several aspects and embodiments of the invention employ a keyword assignment method that reflects the preference of the user. Specifically, a detailed keyword is assigned to a field that is of interest for the user, and a broad keyword is assigned to a field that is not of much interest for the user. More specifically, when the user likes to photograph a cat, a detailed keyword (e.g., “Japanese cat”, “Persian”, or “Abyssinian”) is assigned to cat image data. In contrast, a broad keyword (e.g., “bird”) is assigned to bird image data that is not of much interest for the user. This makes it possible to prevent a situation in which a large number of images are found by a specific keyword. Therefore, it is possible to improve the keyword assignment effect and the image search efficiency.

A specific method is described below. A configuration example, a specific process, classification, a higher hierarchy reference method, a specific example thereof, a specific search application example, and a modification are sequentially described below.

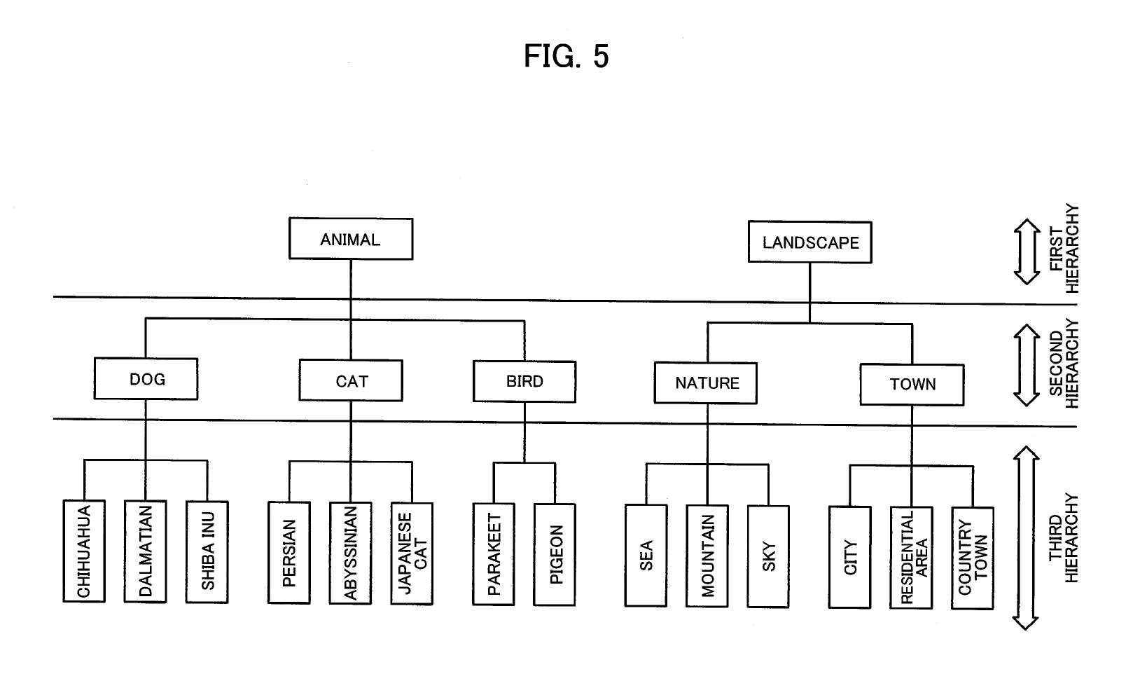

Note that the following description is given taking the hierarchical structure (classification) illustrated in FIG. 5 as an example. The hierarchical structure illustrated in FIG. 5 is an example of a three-hierarchy structure that includes first to third hierarchies. Note that the embodiments of the invention are not limited thereto. The method according to the embodiments of the invention may also be applied to a hierarchical (class) structure that includes first to Nth (N is an integer equal to or larger than 2) hierarchies.

### 2. Configuration Example and Specific Process

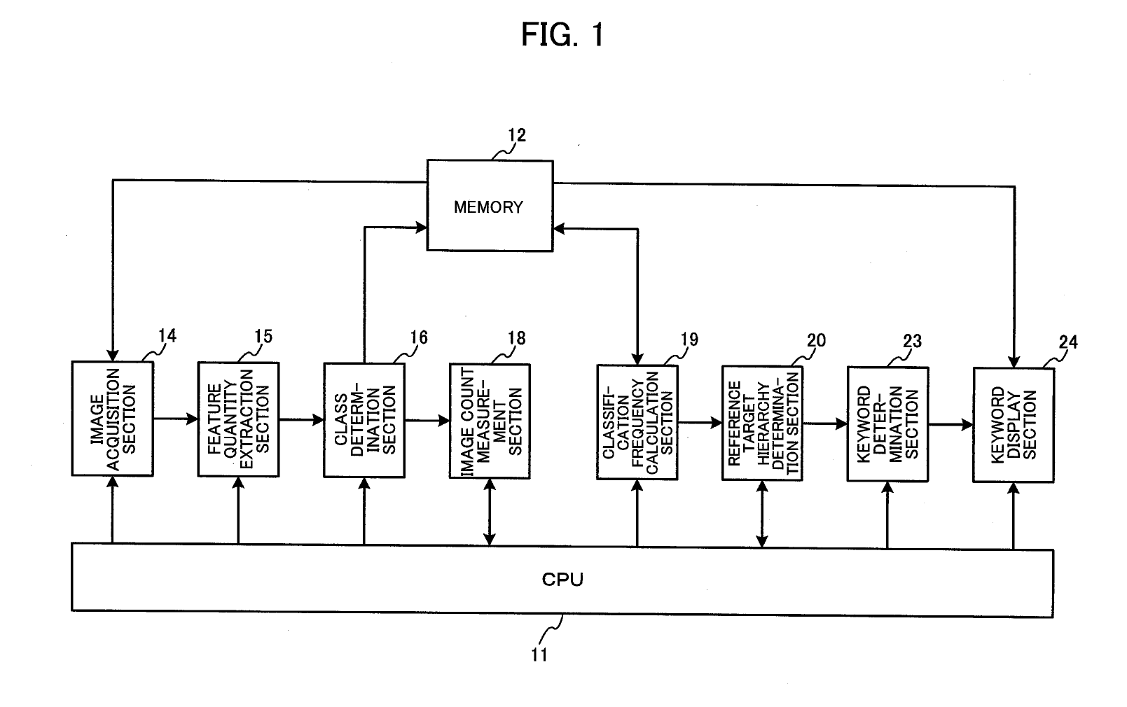

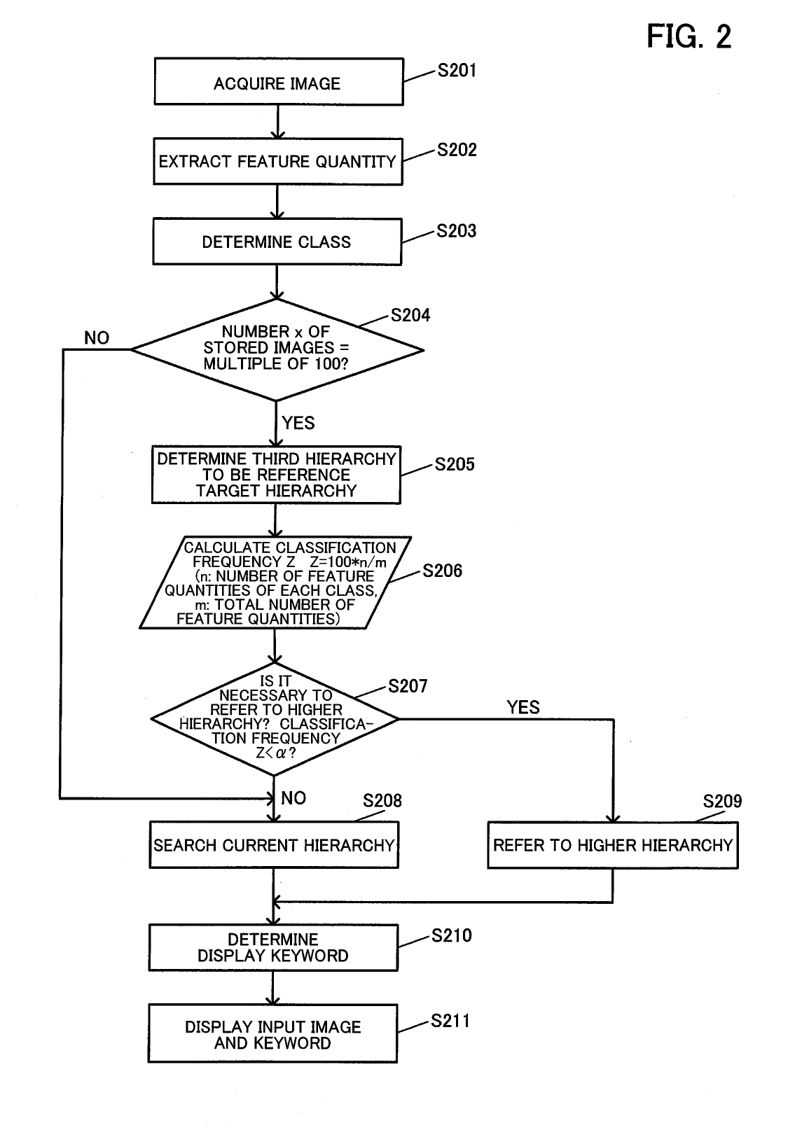

FIG. 1 illustrates a processing system according to one embodiment of the invention, and FIG. 2 is a flowchart illustrating the flow of the entire process. An operation implemented by the configuration illustrated in FIG. 1 is described below using the flowchart illustrated in FIG. 2.

An image acquisition section 14 reads the keyword assignment target image from a memory 12, and outputs the keyword assignment target image (input image) read from the memory 12 to a feature quantity extraction section 15 (S201).

The feature quantity extraction section 15 extracts a feature quantity (vector) from the input image, and outputs the extracted feature quantity to a class determination section 16 (S202).

The class determination section 16 classifies the extracted feature quantity (vector) in the feature space, and determines a corresponding class that is a class that corresponds to the input image. The class determination section 16 outputs the corresponding class determination result to an image count measurement section 18 and the memory 12 (S203). Note that a plurality of feature quantities (vectors) may be extracted from one image when the image includes a plurality of objects. When a plurality of feature quantities (vectors) have been extracted from one image, a plurality of classes in an identical hierarchy are determined to be the corresponding classes.

Note that the corresponding class is selected from each of the first to third hierarchies (first to Nth hierarchies in a broad sense). For example, when a Japanese cat is included in the input image, the class “Japanese cat” in the third hierarchy is determined to be the corresponding class, and the class “cat” in the second hierarchy and the class “animal” in the first hierarchy are also determined to be the corresponding classes. Whether or not it is necessary to refer to the higher hierarchy is determined for the corresponding class in the lower hierarchy, and the process is performed referring to the corresponding class in the higher hierarchy when it is necessary to refer to the higher hierarchy (described later). Note that it suffices that the corresponding class in the lower hierarchy be linked to the class in the higher hierarchy via a tree structure (i.e., it suffices to store a tree structure data as illustrated in FIG. 5 that is acquired by learning). Therefore, the corresponding class may be selected from the classes in the lowest hierarchy, and may not be selected from the classes in the higher hierarchy.

The image count measurement section 18 measures the number of processed input images based on a signal input from the class determination section 16. Whether or not a specific number of (e.g., a multiple of 100) images have been processed is determined based on the measurement result of the image count measurement section 18 (S204). When the number of processed images is smaller than a multiple of 100, the current hierarchy is searched (S208), and the keyword of the class in the third hierarchy is selected as the display keyword.

The third hierarchy is then determined to be the first reference target hierarchy (S205), and a classification frequency calculation section 19 calculates the classification frequency Z of each class from the classified images stored in the memory 12 (S206). The classification frequency calculation section 19 calculates the classification frequency Z (%) of each class using the following expression (1) (where, m is the total number of feature quantities of the classified images, and n is the number of feature quantities that fall under each class) (S206).

Z=100×n/m (1)

The total number of times that each class has been determined to be the corresponding class for 100 images corresponds to m, and the number of times that the classification frequency calculation target class has been determined to be the corresponding class corresponds to n. For example, m=300 when the classes have been determined to be the corresponding classes 300 times for 100 images (i.e., 300 feature quantities have been extracted from 100 images), and the number of times that the classification frequency calculation target class has been determined to be the corresponding class is n. For example, n=60 when the class “Japanese cat” has been determined to be the corresponding class 60 times (i.e., the feature quantity that corresponds to the class “Japanese cat” has been extracted 60 times). In this case, the classification frequency of the class “Japanese cat” is calculated to be Z=100×n/m=100×60/300=20(%).

Note that the classification frequency is calculated on a hierarchy basis. In the example illustrated in FIG. 5, the classification frequency of each class in the third hierarchy is first calculated, and the classification frequency of each class in the second hierarchy is then calculated. The classification frequency of each class in the second hierarchy may be calculated using the calculation results for the third hierarchy. For example, the total number of times that the classes “Chihuahua”, “Dalmatian”, and “Shiba Inu” have been determined to be the corresponding classes may be used as the number of times that the class “dog” has been determined to be the corresponding class. Alternatively, the total classification frequency of the classes “Chihuahua”, “Dalmatian”, and “Shiba Inu” may be used as the classification frequency of the class “dog”. Note that such a process requires that the classes in the lower hierarchy cover the classes in the higher hierarchy. Specifically, when a feature quantity that belongs to the class “dog”, but does not belong to the classes “Chihuahua”, “Dalmatian”, and “Shiba Inu” has been extracted, and such a feature quantity is not necessarily assigned to the class “Chihuahua”, “Dalmatian”, or “Shiba Inu”, the total number of times that the classes in the lower hierarchy have been determined to be the corresponding classes may not coincide with the number of times that the class in the higher hierarchy has been determined to be the corresponding class.

The classification frequency of each class thus calculated is input to a reference target hierarchy determination section 20 that determines the reference target hierarchy, and determines whether or not it is necessary to refer to another hierarchy.

The reference target hierarchy determination section 20 determines whether or not it is necessary to refer to the higher hierarchy based on the classification frequency of each class in the current reference target hierarchy (S207). Whether or not it is necessary to refer to the higher hierarchy is determined by determining whether or not the classification frequency is smaller than a given value a on a class basis. It is preferable that the value a be larger than the average value of the classification frequencies of all of the classes.

When the classification frequency of some class is smaller than the value a, it is determined that it is necessary to refer to the higher hierarchy. Specifically, the higher hierarchy is determined to be the next reference target hierarchy. The classification frequency of the class in the higher hierarchy and a threshold value α (that may differ from the value α) are then compared to determine whether or not it is necessary to further refer to the higher hierarchy.

A keyword determination section 23 determines the keyword of the class in the current reference target hierarchy to be the display keyword for the class for which it has been determined that it is unnecessary to refer to the higher hierarchy (S210).

The information about the keyword determined by the keyword determination section 23 is input to a keyword display section 24, and displayed together with the input image input from the memory 12 (S211).

The classification frequency calculation section 19 performs the classification frequency calculation process on each class, and the results of the classification frequency calculation process are stored in the memory 12. Specifically, even if an image of a Japanese cat has been input, and the classification frequency calculation process is performed on the class “Japanese cat”, the classification frequency calculation process need not necessarily be performed on only the class “Japanese cat”. A keyword can be assigned without performing the classification frequency calculation process each time a new input image has been input by performing the classification frequency calculation process on each class (e.g., “Chihuahua” and “Dalmatian”) (including each class in the higher hierarchy) in advance.

The reference target hierarchy determination section 20 may also perform the reference target hierarchy determination process on each class. Since the threshold value a is set in advance, the reference relationship between each class can be determined regardless of the current input image by calculating the classification frequency of each class. For example, when the classification frequency of the class “Japanese cat” is high, the keyword “Japanese cat” is assigned to the input image. The second hierarchy is referred to for the class “Dalmatian”, and the keyword “dog” is assigned to the input image. The first hierarchy is referred to for the class “country town”, and the keyword “landscape” is assigned to the input image. This makes it unnecessary to determine whether or not it is necessary to refer to the higher hierarchy each time the input image has been input. For example, when an input image has been input for which the classes “Dalmatian”, “Japanese cat”, and “country town” in the third hierarchy are determined to be the corresponding classes, the keywords “dog”, “Japanese cat”, and “landscape” can be assigned to the input image without determining whether or not it is necessary to refer to the higher hierarchy.

### 3. Classification

The details of classification are described below. The class determination section 16 has learned classification that is set in advance. Specifically, images (learning data) to which a correct keyword is manually assigned are provided in advance. A feature quantity (vector) is extracted from these images, and input to the class determination section 16. The feature quantity may be an arbitrary feature quantity that is appropriate for classifying the learning data, and may be selected from various feature quantities (e.g., hue, chroma, luminance, shape, size, and position) included in the image, and various feature quantities (e.g., imaging information (e.g., ISO speed) included in the Exif information) that have been added to the image. The feature quantity extraction section 15 is configured to extract the feature quantity that is employed in the learning process.

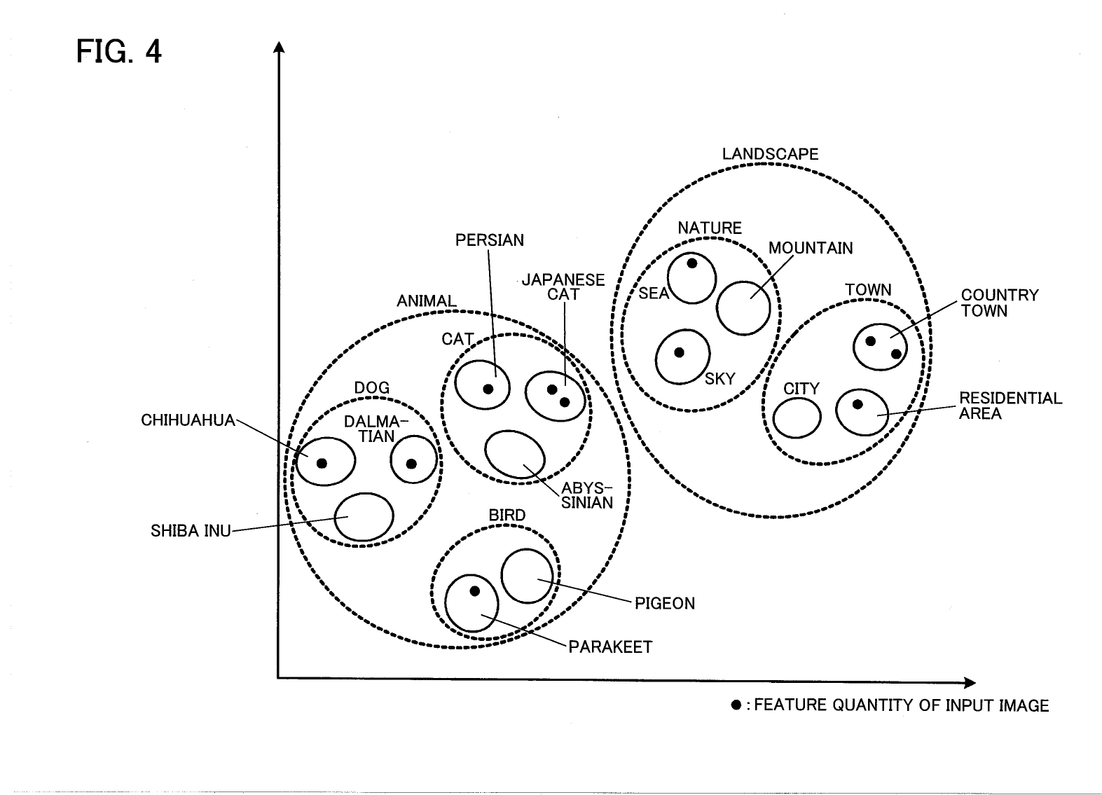

The class determination section 16 disposes the feature quantity (vector) of the input image (learning data) in the feature space (see FIG. 4), and forms a classification boundary so that images to which an identical keyword is assigned are classified into the same class in the feature space. An arbitrary method may be used for classification. For example, the k-nearest neighbor algorithm may be used for classification. Note that the feature space is illustrated in FIG. 4 as a two-dimensional space for convenience. The actual feature space is an N-dimensional space. Note that N is an arbitrary natural number.

In FIG. 4, each black circle corresponds to the input image data, and each closed area indicates the classification boundary of the class corresponding to each keyword. Each closed area drawn by the solid line is used for classification, and each closed area drawn by the dotted line is illustrated so that the relationship with the classification tree illustrated in FIG. 5 can be easily understood.

The keywords that are manually assigned to images have the hierarchical structure illustrated in FIG. 5, for example. The keyword in the higher hierarchy occupies a larger area in the feature space, and includes the area of the keyword in the lower hierarchy. Note that the classification tree illustrated in FIG. 5 is merely an example. The keywords and the number of hierarchies are not limited to those illustrated in FIG. 5.

### 4. Reference to Higher Hierarchy

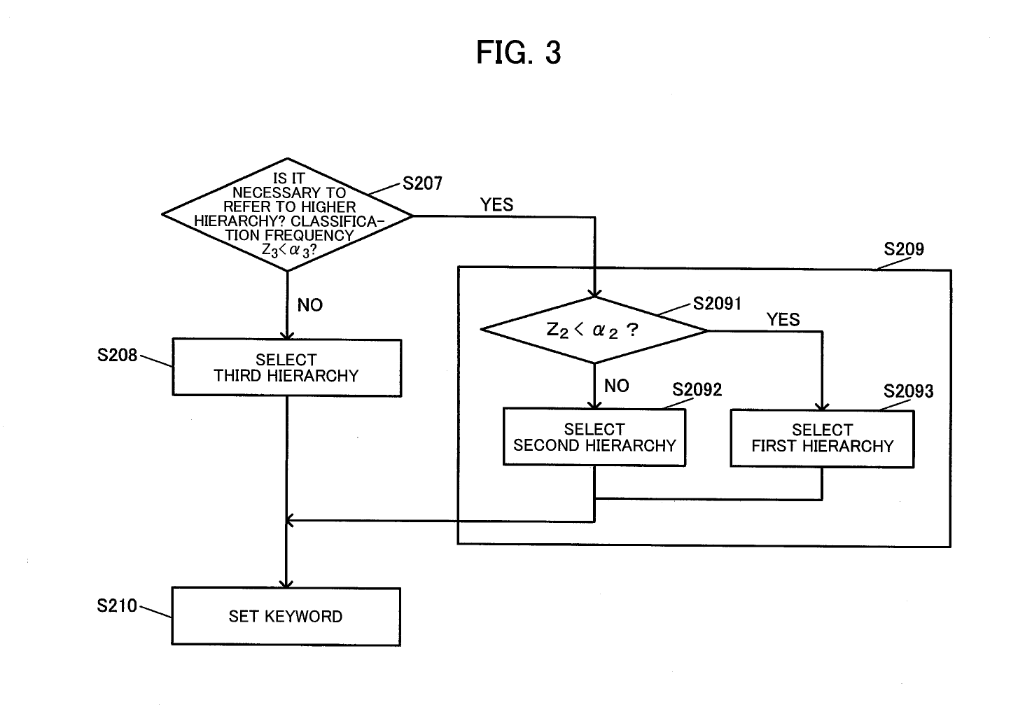

The details of reference to the higher hierarchy (S209 in FIG. 2) are described below. FIG. 3 illustrates the detailed flow of the keyword reference process when the classes have the three-hierarchy structure illustrated in FIG. 5.

The classification frequency of each class in the third hierarchy is referred to as Z3, the classification frequency of each class in the second hierarchy is referred to as Z2, the threshold value used for the third hierarchy is referred to as α3, and the threshold value used for the second hierarchy is referred to as α2.

When the reference target hierarchy determination section 20 (S207) has determined that the classification frequency Z3 of an arbitrary class in the third hierarchy is smaller than the threshold value α3, and it is necessary to refer to the keyword in the higher hierarchy, the reference target hierarchy determination section 20 determines whether or not the classification frequency Z2 of the class in the second hierarchy is smaller than the threshold value α2 (S2091). In this case, the total number of feature quantities of all of the classes in the third hierarchy that are included in the class in the second hierarchy is used as the classification frequency Z2 of the class in the second hierarchy. When the number of feature quantities of each class in the third hierarchy included in the class in the second hierarchy is a1, a2, . . . , the number n2 of feature quantities of the class in the second hierarchy is calculated by the following expression (2).

$${n}_{2} = {\sum }_{k = 1}^{n} {a}_{k} \qquad ( 2 )$$

Therefore, when the number of feature quantities of the entire second hierarchy is m2, the classification frequency Z2 is calculated by the following expression (3).

Z2=100×n2/m2 (3)

When the classification frequency Z2 of the class in the second hierarchy is not smaller than the threshold value α2, the keyword of the class in the second hierarchy is referred to (S2092). When the classification frequency Z2 of the second hierarchy is smaller than the threshold value α2, the keyword of the class in the first hierarchy is referred to (S2093). Note that the threshold values α3 and α2 need not necessarily satisfy the relationship “α3>α2”.

### 5. Specific Example of Reference to Higher Hierarchy

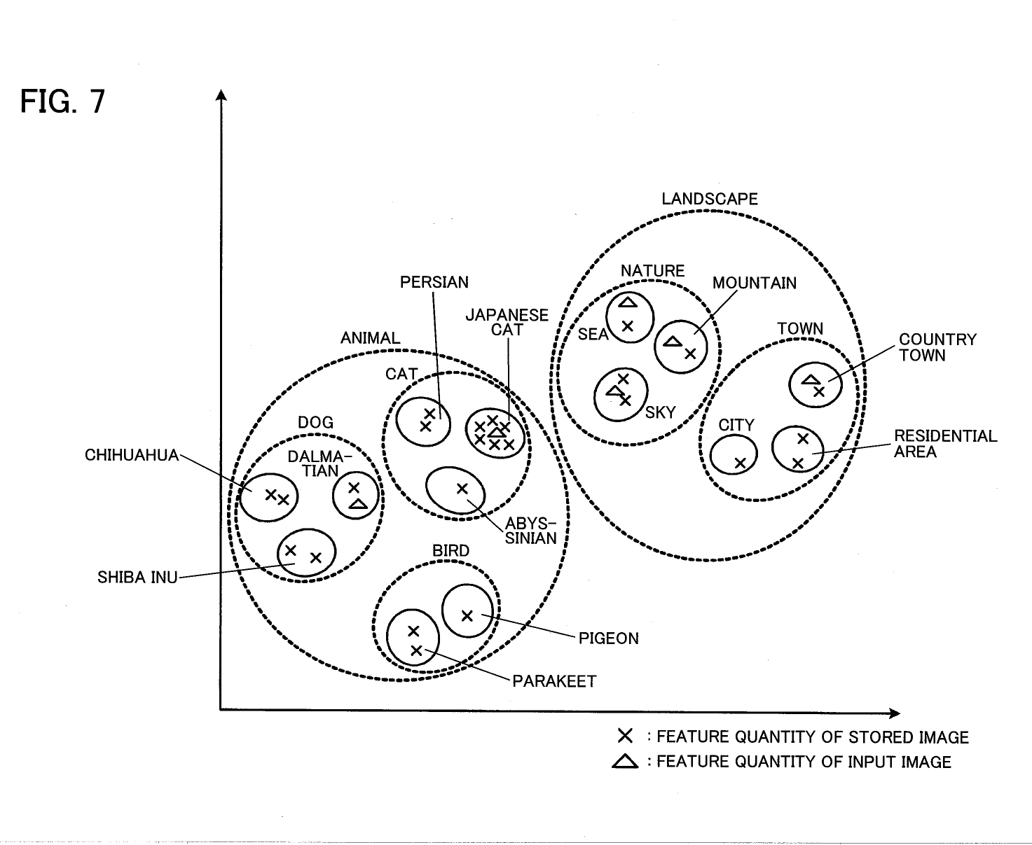

A specific example of the flow until the keyword is displayed after the image has been input is described below. The following description is given on the assumption that the image illustrated in FIG. 6 has been input, the classification results using the feature space are obtained as illustrated in FIG. 7, and the keywords are classified as illustrated in FIG. 5 using the classification tree.

The feature quantities are extracted from the input image, and the corresponding classes are determined based on the class structure illustrated in FIG. 4. FIG. 7 illustrates the class determination results using the feature space.

The classes “Dalmatian”, “Japanese cat”, “sea”, “mountain”, “sky”, and “country town” are determined to be the corresponding classes that correspond to the feature quantities extracted from the input image as a result of the class determination process.

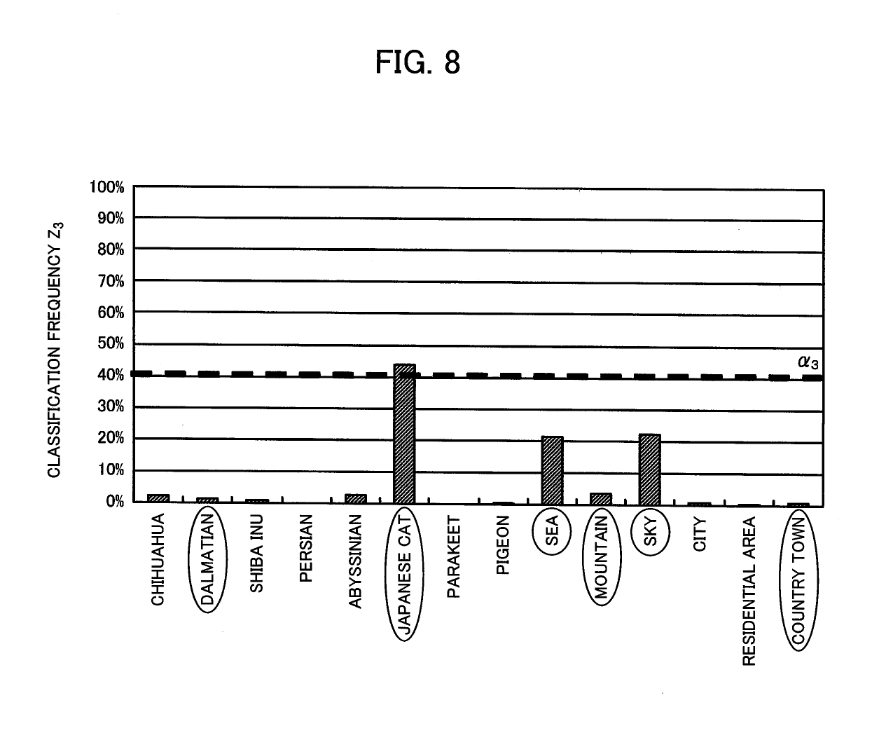

When the number x of stored images is a multiple of 100, the classification frequency Z3 of each class is calculated. FIG. 8 illustrates the calculation results as a graph. Each encircled class is the corresponding class. The threshold value α3 is set to 40 (see the dotted line in FIG. 8).

As illustrated in FIG. 8, the class “Japanese cat” among the encircled classes does not satisfy the relationship “Z3<α3”. Therefore, the keyword “Japanese cat” of the corresponding class in the current reference target hierarchy is determined to be the display keyword.

The classes “Dalmatian”, “sea”, “mountain”, “sky”, and “country town” among the encircled classes satisfy the relationship “Z3<α3”. The display keyword is not determined for these corresponding classes in this stage, and the second hierarchy (higher hierarchy) is referred to.

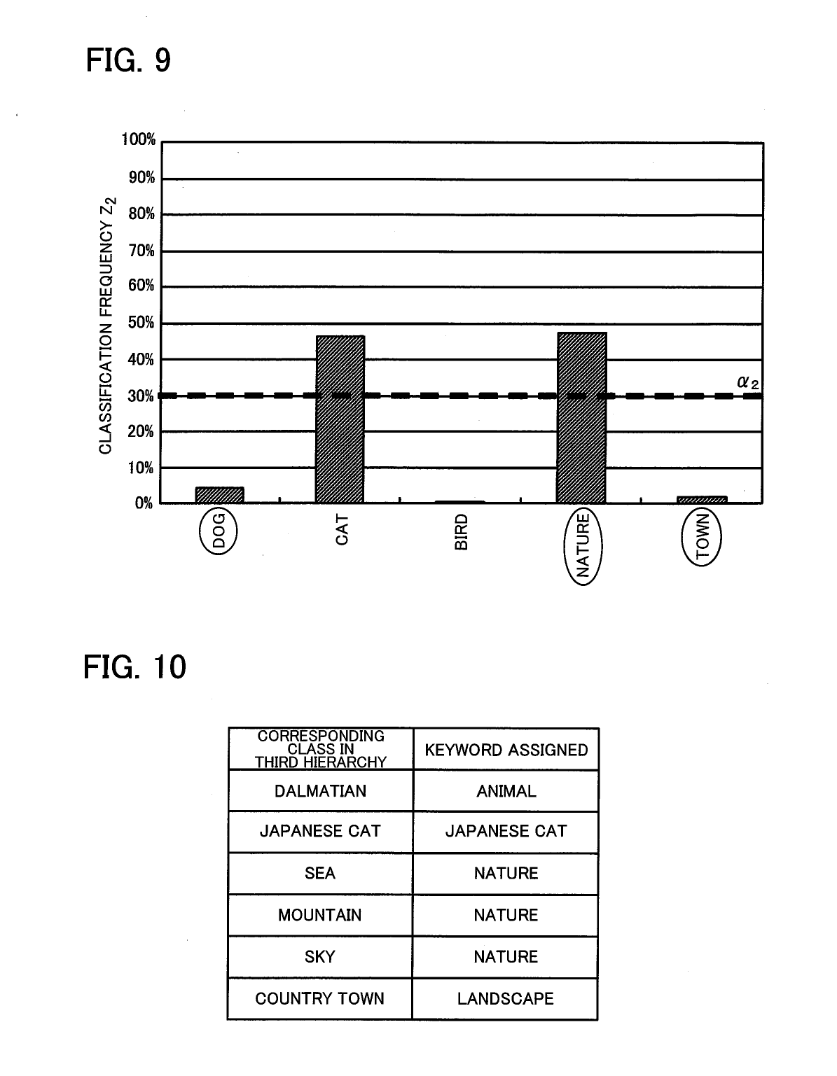

The classification frequency Z2 of the class in the second hierarchy is then calculated. FIG. 9 illustrates the calculation results as a graph. Each encircled class is the corresponding class in the second hierarchy. The threshold value α2 is set to 30 (see the dotted line in FIG. 9).

Since the class in the second hierarchy that corresponds to the class “Dalmatian” is “dog” (see FIG. 5), and the class “dog” satisfies the relationship “Z2<α2” (see FIG. 9), the display keyword is not determined in this stage, and the corresponding class “animal” in the first hierarchy (higher hierarchy) is referred to.

Since the class in the second hierarchy that corresponds to the classes “sea”, “mountain”, and “sky” is “nature”, and the class “nature” does not satisfy the relationship “Z2<α2” (see FIG. 9), the keyword “nature” in the second hierarchy is determined to be the display keyword.

Since the class in the second hierarchy that corresponds to the class “country town” is “town”, and the class “town” satisfies the relationship “Z2<α2” (see FIG. 9), the display keyword is not determined in this stage, and the corresponding class “landscape” in the first hierarchy (higher hierarchy) is referred to.

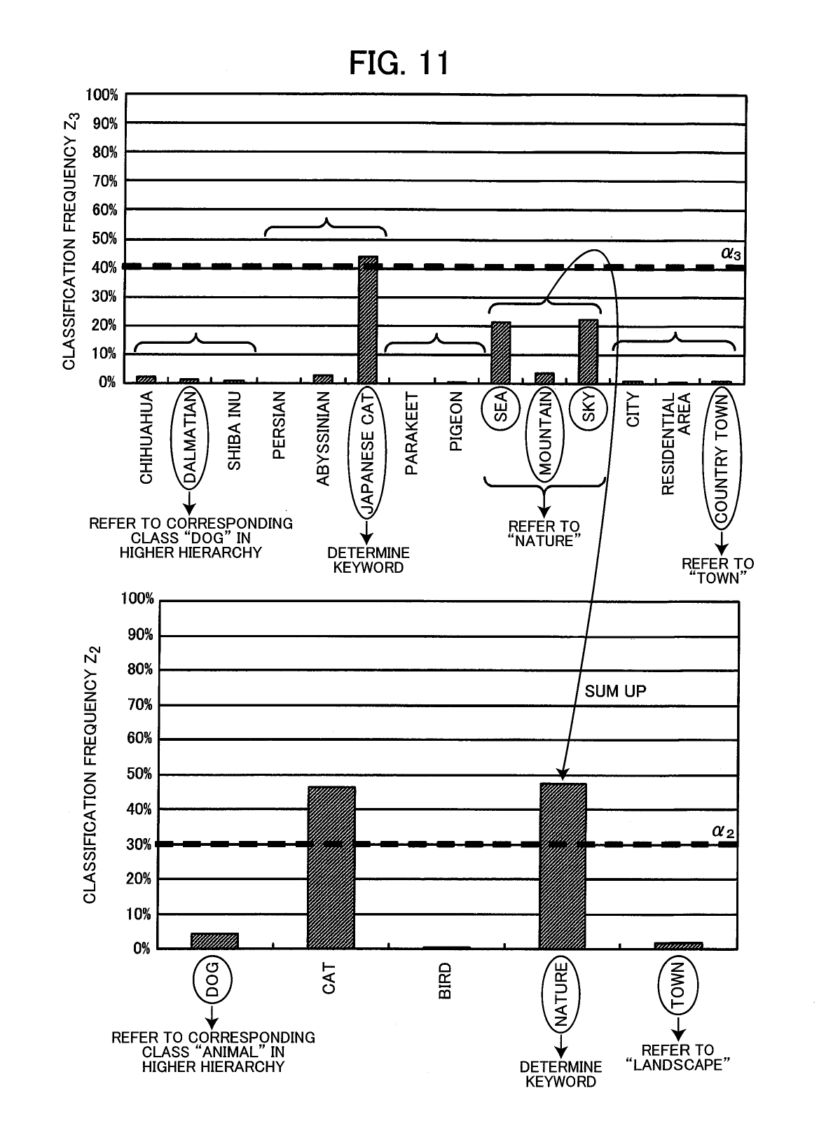

As a result, the keywords “animal”, “Japanese cat”, “nature”, and “landscape” are determined to be the display keywords from the corresponding classes “Dalmatian”, “Japanese cat”, “sea”, “mountain”, “sky”, and “country town” (see FIG. 10), and displayed on the screen together with the input image. FIG. 11 illustrates the above process (see FIGS. 8 and 9) in more detail.

The current state is stored in the memory until the subsequent classification frequency calculation process is performed. When the number of stored images is not a multiple of 100, the classification frequency calculation process is not performed, and the display keyword is determined from the classification results based on the corresponding class in the third hierarchy and the results of the reference process stored in the memory.

### 6. Specific Example of Search Application

When the user searches the desired image by inputting or selecting a keyword, the search keywords are changed corresponding to the classification frequency of the stored image in the same manner as in the case of assigning a keyword. Detailed keywords are displayed as the search keywords for the category that is considered to be of interest for the user.

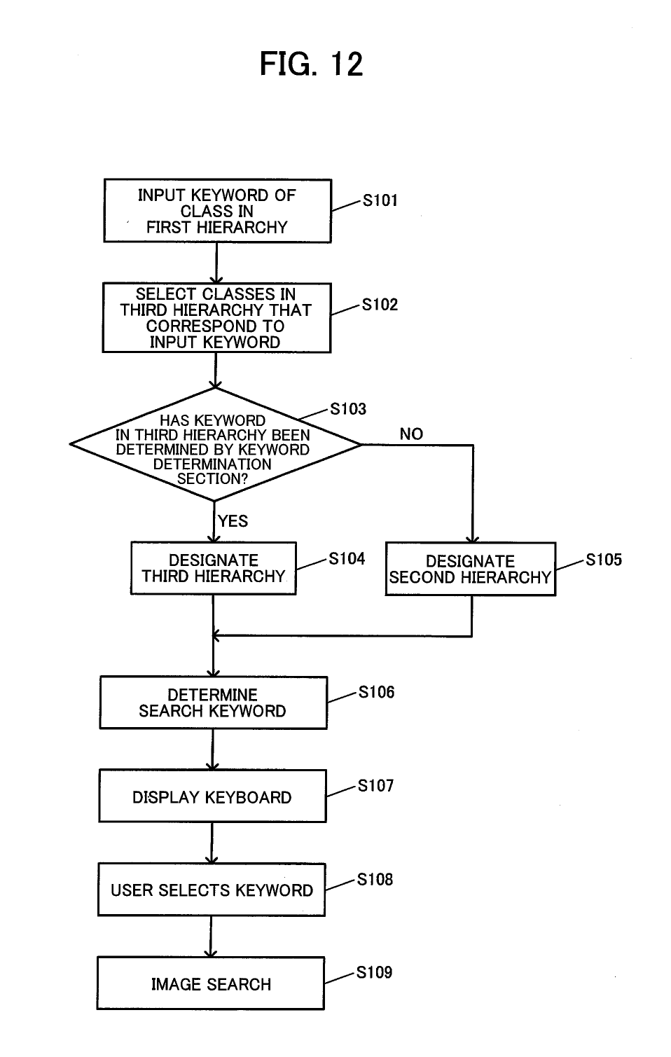

FIG. 12 illustrates the flow of the process until the image is displayed after the user has selected the search keyword on the assumption that the search keywords have the hierarchical structure illustrated in FIG. 5, and the user selects the search keyword from the keywords of the classes in the first hierarchy.

The keyword of the class in the first hierarchy that has been selected by the user is input (S101). The classes in the third hierarchy that correspond to the input keyword are then selected (S102). In this case, the process is performed on all of the classes in the third hierarchy that correspond to the input keyword.

Next, whether or not the keyword of the corresponding class in the third hierarchy has been assigned is determined (S103). The third hierarchy is designated when the keyword of the corresponding class in the third hierarchy has been assigned (S104), and the second hierarchy is designated when the keyword of the second hierarchy or the first hierarchy has been assigned (S105).

All of the keywords of the designated hierarchy are determined to be search candidate keywords (S106), and displayed (S107).

The user selects the search keyword from the displayed keywords (S108), and an image search process is performed using the selected search keyword (S109).

For example, when the user has selected the keyword “animal”, the classes “Chihuahua”, “Dalmatian”, “Shiba Inu”, “Persian”, “Abyssinian”, “Japanese cat”, “parakeet”, and “pigeon” in the third hierarchy are selected (see FIG. 5). The hierarchy to which the keyword assigned to each class belongs is then determined. When the keyword in the third hierarchy has been assigned to only the class “Japanese cat”, the third hierarchy is designated for only the class “Japanese cat”, and the second hierarchy is designated for the remaining classes. Therefore, the keywords “dog”, “cat”, “Japanese cat”, and “bird” are displayed as the search keywords.

The keywords “Persian” and “Abyssinian” in the third hierarchy may be displayed as the search keyword “other cat”. Since the keyword “Japanese cat” is used as the search keyword, it is considered that a number of Japanese cat images are stored. Therefore, a large number of cat images including a large number of Japanese cat images are found when the images are searched using the keyword “cat” (i.e., a broader concept of the keyword “Japanese cat”) as the search keyword, and it is difficult to find the desired image. Specifically, when the keyword “Japanese cat” (narrower concept) and the keyword “cat” (broader concept) appear at the same time, it can be determined that the keyword “cat” (broader concept) appears due to a cat other than a Japanese cat. In this case, the Japanese cat images can be excluded from the search target by displaying the search keyword “other cat” as a keyword corresponding to the classes “Persian” and “Abyssinian”, so that a more efficient search process can be implemented.

### 7. Modifications

The class (keyword) hierarchical structure may be configured so that a plurality of classes in the higher hierarchy correspond to one class in the lower hierarchy. Each hierarchy is independent from the others, and the keyword of the class in each higher hierarchy is referred to when referring to the keyword of the class in the higher hierarchy based on the classification frequency.

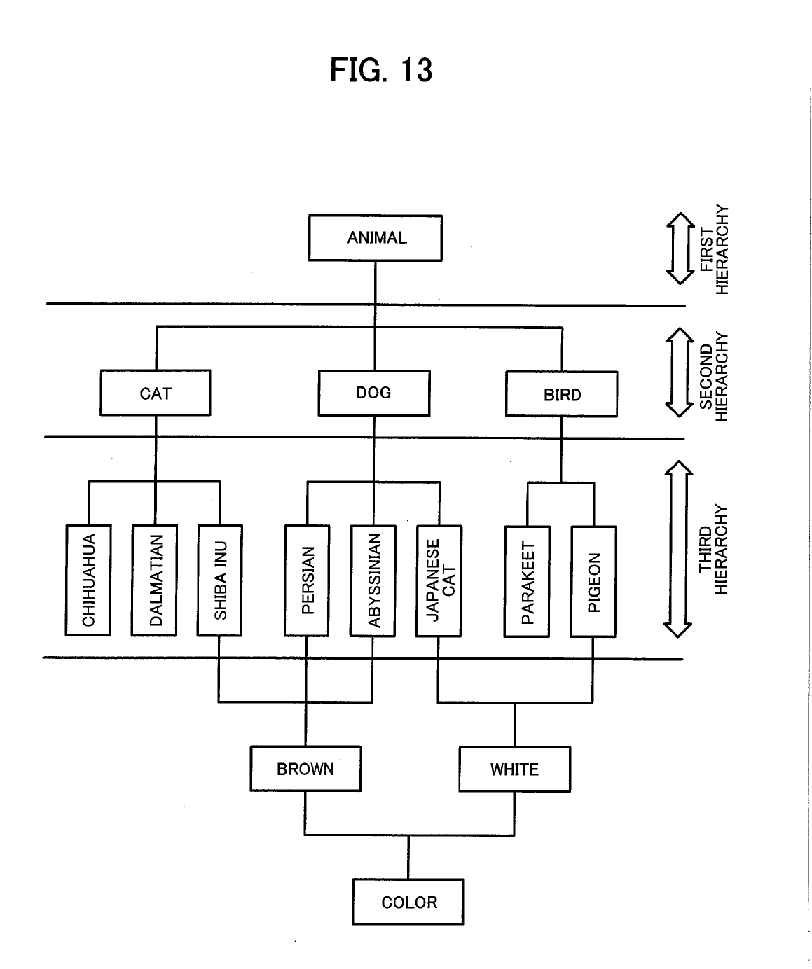

FIG. 13 illustrates an example in which the hierarchy “color” is provided in addition to the hierarchy “animal”. In this case, the keywords “cat” and “white” are referred to for the class “Japanese cat”.

According to the above embodiments, a keyword assignment device includes the class determination section 16 that determines the corresponding class based on the feature quantity of the input image when a plurality of keywords are classified into a plurality of classes that are distributed in first to Nth hierarchies (see FIG. 5, for example), the classification frequency calculation section 19 that calculates the classification frequency of each class among the plurality of classes, the reference target hierarchy determination section 20 that determines the reference target hierarchy, and the keyword determination section 23 that determines the keyword of the corresponding class in the final reference target hierarchy determined by the reference target hierarchy determination section 20 to be the display keyword (see FIG. 1). The reference target hierarchy determination section 20 determines whether or not it is necessary to refer to a kth (k is an integer that satisfies 1≦k<j) hierarchy that is higher than a jth (j is an integer that satisfies 1≦j≦N) hierarchy based on the classification frequency in the jth hierarchy, and determines the kth hierarchy to be the next reference target hierarchy when the reference target hierarchy determination section 20 has determined that it is necessary to refer to the kth hierarchy.

The term “corresponding class” used herein refers to a class that corresponds to the input image. For example, when the input image is the image illustrated in FIG. 6, and the keywords are classified as illustrated in FIG. 5, the classes “Dalmatian”, “Japanese cat”, “sea”, “mountain”, “sky”, and “country town” in the third hierarchy are determined to be the corresponding classes. The classes “dog”, “cat”, “nature”, and “town” in the second hierarchy (higher hierarchy) and the classes “animal” and “landscape” in the first hierarchy (higher hierarchy) are also determined to be the corresponding classes. The term “reference target hierarchy” used herein refers to a hierarchy that is referred to for the classification frequency. The classification frequency of each class is calculated when a specific number of (e.g., 100) images have been acquired. The classification frequency is calculated on a hierarchy basis, and the reference target hierarchy indicates the hierarchy of which the classification frequency is used for the process.

The above configuration makes it possible to calculate the classification frequency of each class, and perform the process using the classification frequency calculated for a specific hierarchy as the reference target hierarchy. Specifically, whether or not it is necessary to refer to the higher hierarchy is determined based on the classification frequency in the reference target hierarchy, and the higher hierarchy is referred to when it is necessary to refer to the higher hierarchy. This makes it possible to refer to the higher hierarchy as required, based on the classification frequency. Since the keyword in the final reference target hierarchy is determined to be the display keyword, the keyword assignment device can optionally assign the keyword in the higher hierarchy while giving priority to the keyword in the lower hierarchy.

The reference target hierarchy determination section 20 may determine the jth hierarchy to be the final reference target hierarchy when the reference target hierarchy determination section 20 has determined that it is unnecessary to refer to the hierarchy higher than the jth hierarchy based on the classification frequency in the jth hierarchy. The keyword determination section may determine the keyword of the corresponding class in the jth hierarchy to be the display keyword assigned to the input image.

This makes it possible to terminate the higher hierarchy reference process when it has been determined that it is unnecessary to refer to the higher hierarchy, and determine the current reference target hierarchy to be the final reference target hierarchy. Specifically, since the higher hierarchy reference process that sequentially refers to the higher hierarchy from the lower hierarchy can be terminated halfway, the keyword in an arbitrary hierarchy can be determined to be the display keyword.

The reference target hierarchy determination section 20 may determine the Nth hierarchy that is the lowest hierarchy to be the first reference target hierarchy, and may determine whether or not it is necessary to refer to the hierarchy higher than the Nth hierarchy based on the classification frequency in the Nth hierarchy. Specifically, the third hierarchy illustrated in FIG. 5 may be determined to be the first reference target hierarchy. The higher hierarchy may be determined to be the next reference target hierarchy when it is necessary to refer to the higher hierarchy. The Nth hierarchy may be determined to be the final reference target hierarchy when it is unnecessary to refer to the higher hierarchy, and the keyword of the corresponding class in the Nth hierarchy may be determined to be the display keyword assigned to the input image.

This makes it possible to start the reference process from the lowest hierarchy. Since the reference process is performed from the lower hierarchy to the higher hierarchy, it is impossible to refer to the hierarchy lower than an intermediate hierarchy when the reference process is started from the intermediate hierarchy. Therefore, it is very important to start the reference process from the lowest hierarchy in order to make it possible to refer to an arbitrary hierarchy.

The reference target hierarchy determination section 20 may determine the kth hierarchy that is higher than the jth hierarchy to be the next reference target hierarchy when the classification frequency of the corresponding class in the jth hierarchy is smaller than a given threshold value. The reference target hierarchy determination section 20 may stop referring to the higher hierarchy when the classification frequency of the corresponding class in the jth hierarchy is larger than the given threshold value, and determine the jth hierarchy to be the final reference target hierarchy.

This makes it possible to determine whether or not it is necessary to refer to the higher hierarchy by comparing the classification frequency with the threshold value. The keyword in the lower hierarchy is assigned when the classification frequency is high, and the keyword in the higher hierarchy is assigned when the classification frequency is low, as a result of referring to the higher hierarchy when the classification frequency is smaller than the threshold value, and not referring to the higher hierarchy when the classification frequency is larger than the threshold value. It is possible to implement a more flexible process by setting a different threshold value to the jth hierarchy and the kth hierarchy.

The classification frequency may be calculated as described below when the class determination section 16 has determined one corresponding class or a plurality of corresponding classes for each input image among a plurality of input images. Specifically, when the total class determination count of all of the classes that belong to a given hierarchy is referred to as m, and the class determination count of the classification frequency reference target class is referred to as n, the classification frequency is calculated based on “n/m”.

The term “class determination count” used herein refers to the number of times that each class has been determined to be the corresponding class by the class determination section 16. For example, when the image illustrated in FIG. 6 has been input, the classes “Dalmatian”, “Japanese cat”, “sea”, “mountain”, “sky”, and “country town” are determined to be the corresponding classes, and the class determination count of each of these classes is incremented by 1.

This makes it possible to calculate the classification frequency using a simple expression, and facilitates the process. It is necessary to perform the process that determines the corresponding class when the input image has been input in order to assign the keyword to the input image. Therefore, the classification frequency can be calculated during the keyword assignment process without performing a special process that calculates the classification frequency.

The keyword assignment device may include the keyword display section 24 that displays the keyword determined by the keyword determination section 23 (see FIG. 1). The keyword display section 24 may present the keyword of the corresponding class in the hierarchy other than the reference target hierarchy determined by the reference target hierarchy determination section 20 as a candidate.

This makes it possible to display the keyword. It is considered that a keyword as a narrower concept and a keyword as a broader concept that includes the narrower concept may be assigned at the same time when using the method according to the above embodiments. Therefore, it may not be effective to display the keyword as a broader concept. For example, the keywords “Japanese cat” and “animal” are assigned to the image illustrated in FIG. 6. However, the keyword “animal” is not very useful for the search process since a number of Japanese cat images are also found by the keyword “animal”. Since the keyword “animal” is assigned based on the class “Dalmatian”, it is possible to implement a smooth search process by displaying the keyword “dog” (narrower concept) instead of the keyword “animal”.

A more detailed keyword may be classified into the classes in the lower hierarchy among the classes distributed in the first to Nth hierarchies.

This makes it possible to implement a classification configuration in which the lower hierarchy corresponds to a narrower concept, and the higher hierarchy corresponds to a broader concept. Therefore, the keyword assignment device that assigns the keyword in the lower hierarchy when the classification frequency is low, and assigns the keyword in the higher hierarchy when the classification frequency is high, assigns a detailed keyword when the classification frequency is high, and assigns a broad keyword when the classification frequency is low. This makes it possible to assign a keyword while reflecting the preference of the user and the like.

The method according to the above embodiments may also be applied to a program that causes a computer to execute a class determination step that determines the corresponding class based on the feature quantity of the input image when a plurality of keywords are classified into a plurality of classes that are distributed in first to Nth hierarchies (see FIG. 5, for example), a classification frequency calculation step that calculates the classification frequency of each class among the plurality of classes, a reference target hierarchy determination step that determines the reference target hierarchy, and a keyword determination step that determines the keyword of the corresponding class in the final reference target hierarchy determined by the reference target hierarchy determination step to be the display keyword. The reference target hierarchy determination step determines whether or not it is necessary to refer to a kth (k is an integer that satisfies 1≦k<j) hierarchy that is higher than a jth (j is an integer that satisfies 1≦j≦N) hierarchy based on the classification frequency in the jth hierarchy, and determines the kth hierarchy to be the next reference target hierarchy when the reference target hierarchy determination section 20 has determined that it is necessary to refer to the kth hierarchy.

This makes it possible to apply the above embodiments to a system (e.g., imaging apparatus) that acquires an image, and performs the keyword assignment process, and a system that stores image data, and processes the stored image data by software processing using a computer system (e.g., PC), for example. The program is stored in an information storage device. The information storage device may be an arbitrary recording medium that is readable by an optical detection system, such as an optical disk (e.g., DVD and CD), a magnetooptical disk, a hard disk (HDD), and a memory (e.g., nonvolatile memory and RAM).

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention. Any term cited with a different term having a broader meaning or the same meaning at least once in the specification and the drawings can be replaced by the different term in any place in the specification and the drawings. The configuration and the operation of the keyword assignment device are not limited to those described in connection with the above embodiments. Various modifications and variations may be made.

What is claimed is:

1. A keyword assignment device comprising:
a class determination section that determines a corresponding class based on a feature quantity extracted from an input image when a plurality of keywords are classified into a plurality of classes that are distributed in first to Nth (N is an integer equal to or larger than 2) hierarchies, the corresponding class being a class that corresponds to the input image;
a classification frequency calculation section that calculates a classification frequency of each class among the plurality of classes;
a reference target hierarchy determination section that determines a reference target hierarchy, the reference target hierarchy being a hierarchy that is referred to for the classification frequency; and
a keyword determination section that determines the keyword of the corresponding class in a final reference target hierarchy determined by the reference target hierarchy determination section to be a display keyword assigned to the input image,
the reference target hierarchy determination section determining whether or not it is necessary to refer to a kth (k is an integer that satisfies 1≦k<j) hierarchy that is higher than a jth (j is an integer that satisfies 1≦j≦N) hierarchy based on the classification frequency of the corresponding class in the jth hierarchy when the jth hierarchy is a current reference target hierarchy, and determining the kth hierarchy to be a next reference target hierarchy when the reference target hierarchy determination section has determined that it is necessary to refer to the kth hierarchy.

2. The keyword assignment device as defined in claim 1,
the reference target hierarchy determination section determining the jth hierarchy to be the final reference target hierarchy when the reference target hierarchy determination section has determined that it is unnecessary to refer to a hierarchy higher than the jth hierarchy based on the classification frequency of the corresponding class in the jth hierarchy, and
the keyword determination section determining the keyword of the corresponding class in the jth hierarchy to be the display keyword assigned to the input image.

3. The keyword assignment device as defined in claim 2,
the reference target hierarchy determination section determining an Nth hierarchy that is a lowest hierarchy to be a first reference target hierarchy, and determining whether or not it is necessary to refer to a hierarchy higher than the Nth hierarchy based on the classification frequency of the corresponding class in the Nth hierarchy,
the reference target hierarchy determination section determining the hierarchy higher than the Nth hierarchy to be the next reference target hierarchy when the reference target hierarchy determination section has determined that it is necessary to refer to the hierarchy higher than the Nth hierarchy,
the reference target hierarchy determination section determining the Nth hierarchy to be the final reference target hierarchy when the reference target hierarchy determination section has determined that it is unnecessary to refer to the hierarchy higher than the Nth hierarchy, and
the keyword determination section determining the keyword of the corresponding class in the Nth hierarchy to be the display keyword assigned to the input image when the reference target hierarchy determination section has determined that it is unnecessary to refer to the hierarchy higher than the Nth hierarchy.

4. The keyword assignment device as defined in claim 1,
the reference target hierarchy determination section determining the kth hierarchy that is higher than the jth hierarchy to be the next reference target hierarchy when the classification frequency of the corresponding class in the jth hierarchy is smaller than a given threshold value, and
the reference target hierarchy determination section no longer referring to a higher hierarchy when the classification frequency of the corresponding class in the jth hierarchy is larger than the given threshold value, and determining the jth hierarchy to be the final reference target hierarchy.

5. The keyword assignment device as defined in claim 1,
the classification frequency calculation section calculating the classification frequency based on n/m when the class determination section has determined one corresponding class or a plurality of corresponding classes for each input image among a plurality of input images, m being a total class determination count of a plurality of classes that belong to the reference target hierarchy, and n being a class determination count of a classification frequency reference target class.

6. The keyword assignment device as defined in claim 1, further comprising:
a keyword display section that displays the keyword determined by the keyword determination section.

7. The keyword assignment device as defined in claim 6,
the keyword display section also presenting the keyword of the corresponding class in a hierarchy other than the reference target hierarchy determined by the reference target hierarchy determination section as a candidate.

8. The keyword assignment device as defined in claim 1,
the keyword of each class that belongs to the jth hierarchy being a detailed keyword as compared with the keyword of each class that belongs to the kth hierarchy that is higher than the jth hierarchy.

9. A computer-readable storage device with an executable program stored thereon, the program instructs a computer to perform:
a class determination step that determines a corresponding class based on a feature quantity extracted from an input image when a plurality of keywords are classified into a plurality of classes that are distributed in first to Nth (N is an integer equal to or larger than 2) hierarchies, the corresponding class being a class that corresponds to the input image;
a classification frequency calculation step that calculates a classification frequency of each class among the plurality of classes;
a reference target hierarchy determination step that determines a reference target hierarchy, the reference target hierarchy being a hierarchy that is referred to for the classification frequency; and
a keyword determination step that determines the keyword of the corresponding class in a final reference target hierarchy determined by the reference target hierarchy determination step to be a display keyword assigned to the input image,
the reference target hierarchy determination step determining a kth (k is an integer that satisfies 1≦k<j) hierarchy to be a next reference target hierarchy when it has been determined that it is necessary to refer to the kth hierarchy that is higher than a jth (j is an integer that satisfies 1≦j≦N) hierarchy based on the classification frequency of the corresponding class in the jth hierarchy.

10. A keyword assignment method comprising:
determining a corresponding class based on a feature quantity extracted from an input image when a plurality of keywords are classified into a plurality of classes that are distributed in first to Nth (N is an integer equal to or larger than 2) hierarchies, the corresponding class being a class that corresponds to the input image;
calculating a classification frequency of each class among the plurality of classes;
performing a reference target hierarchy determination process that determines whether or not it is necessary to refer to a kth (k is an integer that satisfies 1≦k<j) hierarchy that is higher than a jth (j is an integer that satisfies 1≦j≦N) hierarchy based on the classification frequency of the corresponding class in the jth hierarchy when the jth hierarchy has been determined to be a reference target hierarchy that is referred to for the classification frequency, and determines the kth hierarchy to be a next reference target hierarchy when it has been determined that it is necessary to refer to the kth hierarchy; and
determining the keyword of the corresponding class in a final reference target hierarchy determined by the reference target hierarchy determination process to be a display keyword assigned to the input image.
